(19) United States
(12) Patent Application Publication
(10) Pub. No.: US 2017/0272185 A1
(43) Pub. Date: Sep. 21, 2017

(54) SYSTEMS AND METHODS FOR REMOTELY ANALYZING THE RF ENVIRONMENT OF A REMOTE RADIO HEAD

(71) Applicant: Alcatel-Lucent USA Inc., Murray Hill, NJ (US)

(72) Inventor: Ajit K Reddy, Cliffwood, NJ (US)

(73) Assignee: Alcatel-Lucent USA Inc., Murray Hill, NJ (US)

(21) Appl. No.: 15/075,025

(22) Filed: Mar. 18, 2016

(51) Int. Cl. H04B 17/345

(52) U.S. Cl. CPC H04B 17/345

(57) ABSTRACT

The radio frequency environment surrounding a tower mounted, remote radio head (RRH) and its internal operation may be monitored without the need to climb the tower where the RRH is mounted. Many measurements, such as time/frequency measurements, may be made without climbing the tower.

### INTRODUCTION

The latest generation of remote radio heads (RRHs) are mounted on top of a radio tower, Accordingly, it is extremely difficult to monitor the radio frequency (RF) environment (e.g., transmitted and received RF signals) and operation of a RRH. Typically, a technician must either climb the tower to plug in a measurement device (e.g., spectrum analyzer) into monitor ports of the RRH or, at a minimum, a technician must drive out to the location of the tower and access monitor ports located at the bottom of the tower inside an electrical equipment structure (e.g., a small building).

Typically, an analysis of the RF environment surrounding an RRH and its operation is done both in the time domain and in the frequency domain. One type of analysis involves detecting the amount of radio interference a given RRH is subjected to, interference that may becaused by a nearby transmitter, perhaps one belonging to another RRH that is operated by a different telecommunications provider. That is, a given radio tower may have multiple RRHs, each one operated by a different provider. When a nearby transmitter is improperly radiating energy into the same or adjacent frequency channels that are used by a particular RRH whose environment and operation are being analyzed, such interference needs to be quickly detected and curtailed in order to prevent the proper operation of the RRH.

Similarly, interference that originates from transmitters mounted on other nearby towers, or interference that originates from power lines, fluorescent lights, motors and other electric equipment needs to be detected and mitigated.

To date, detecting such interference requires a technician to either climb a radio tower or drive out to the location of the tower.

Accordingly, it is desirable to be able to more quickly and accurately measure the frequency and time domain characteristics of signals in the RF environment surrounding an RRH without having to climb a radio tower or drive to the location of the tower.

### SUMMARY

Systems and related methods forremotely analyzing the RF environment of an RRH.

In one embodiment, a system for analyzing the operation of a radio frequency (RF) remote radio head may comprise: a first receiving section operable to receive signals from a tower mounted, remote radio head (RRH), the signals comprising information related to signals from an RF environment at the RRH; a signal processing section operable to process the received signals in the time and frequency domains, and to identify one or more anomalies due to internal or external interfering signals from the RF environment at the RRH; and an interface for displaying a visualization of the one or more anomalies.

The first receiving section, signal processing section and interface may be part of a network element management system located remotely from, or nearby, an RRH.

The received signals may comprise one or more of the following types of data: RF interference, intermodulation distortion, spectral content, flicker noise, additive white Gaussian noise, colored noise, phase noise, carrier frequency, delay, RF signal strength.

In one embodiment the signal processing section may be further operable to detect an anomaly by estimating the spectral content of the signals in the RF environment at the RRH based on the received signal vectors. For example, the signal processing section may further comprise a periodic sequence estimator for estimating spectral content, the periodic sequence estimator represented by the relationship:

$${P}_{xx} ( ω ) = \frac{1}{N} {\vert {\sum }_{n = 0}^{N - 1} x ( n ) {e}^{- j ω n} \vert}^{2} .$$

Alternatively, the signal processing section may further comprise a weighted window power density estimator for reducing a variance of the estimate, where the weighted window power spectral density estimator is reoriented by the relationship: Pₓₓ^{ww}(ω)=Σ_{k=-(N-1)}^{N-1}rₓₓ₍ₖ₎ω(k)e^{-jωk}.

In another embodiment, the signal processing section may be further operable to detect an anomaly by identifying one or more acceptable or interfering RF signals in the RF environment at the RRH from the received signals based on a time and frequency analysis, more particularly, time and frequency estimates of a multicomponent RF signal using the following relationship: TFR(t,ω)=Σₖ₌₁^{N}A(t,ω) F(t,ω)+XT. The signal processing section may further comprise filter banks with transfer functions overlapped in frequency to avoid signal component artifacts, where a filter bank structure may be represented by the relationship: Cₛ={s*hₖ|k=1 . . . N_{filters}}.

Yet further, the signal processing section may be further operable to complete a sub band analysis process to identify signal structures.

In yet another embodiment, the signal processing section may be further operable to detect an anomaly by identifying one or more RF carriers, and each identified carrier's access scheme, in the RF environment at the RRH from the received signal vectors based on power and frequency estimates of each identified carrier, or detect an anomaly by estimating the spectral coherence of the signals in the RF environment at the RRH from the received signals.

In such an embodiment the signal processing section may be operable to compute a frequency response due to interfering signals based on the relationship:

$${C}_{xy} ( f ) = \frac{\vert \overline{{S}_{xy}} ( f ) \vert}{\overline{{S}_{xx}} ( f ) * \overline{{S}_{yy}} ( f )} .$$

The signal processing section may be further operable to detect an anomaly by estimating the spectral density of the signals in the RF environment at the RRH from the received signals.

The systems described herein may additionally comprise one or more data storage sections operable to store received signal vectors, detected anomalies and the displayed visualizations.

In addition to the above components, systems provided by the present invention may include components located at an RRH. For example, such a system may comprise an RRH, RF conversion and filter section for down converting over the air RF signals into digital signals; an RRH signal capture section for capturing the down converted digital signals and preprocessing the signals; and a second transceiving section at the RRH for transmitting the preprocessed signals from the RRH over the network to the first receiving section.

In addition to the systems described above, the present invention provides for related methods. In one embodiment, an illustrative method may analyze the operation of a radio frequency (RF) remote radio head by: receiving signals from a tower mounted, remote radio head (RRH), the signals comprising information related to signals from an RF environment at the RRH; processing the received signals in the time and frequency domains to identify one or more anomalies due to internal or external interfering signals from the RF environment at the RRH; and displaying a visualization of the one or more anomalies.

Such a method may further involve the detection of an anomaly by estimating the spectral content of the signals in the RF environment at the RRH based on the received signals, and/or the detection of an anomaly by identifying one or more acceptable or interfering RF signals in the RF environment at the RRH from the received signals based on a time and frequency analysis.

Additional devices, systems, related methods, features and advantages of the invention will become clear to those skilled in the art from the following detailed description and appended drawings.

### BRIEF DESCRIPTION OF THE DRAWINGS

FIG. 1 depicts a simplified block diagram of a system according to an embodiment.

FIG. 2 depicts another simplified block diagram of a system according to an embodiment.

FIG. 3 depicts a simplified block diagram of a remote radio head according to an embodiment.

FIG. 4 illustrates an exemplary UDP packet format for a single fragment.

FIG. 5 depicts a data capture sequence according to one embodiment.

FIG. 6 depicts a spectral capture of signals according to an embodiment.

FIG. 7 depicts a data capture model according to an embodiment.

### DETAILED DESCRIPTION

Exemplary embodiments for remotely monitoring the RF environment of RRHs are described herein and are shown by way of example in the drawings. Throughout the following description and drawings, like reference numbers/characters refer to like elements.

It should be understood that, although specific exemplary embodiments are discussed herein, there is no intent to limit the scope of the present invention to such embodiments. To the contrary, it should be understood that the exemplary embodiments discussed herein are for illustrative purposes, and that modified and alternative embodiments may be implemented without departing from the scope of the present invention.

It should also be noted that one or more exemplary embodiments may be described as a process or method. Although a process/method may be described as sequential, it should be understood that such a process/method may be performed in parallel, concurrently or simultaneously. In addition, the order of each step within a process/method may be re-arranged. A process/method may be terminated when completed, and may also include additional steps not included in a description of the process/method.

As used herein, the term “and/or” includes any and all combinations of one or more of the associated listed items. As used herein, the singular forms “a,” “an” and “the” are intended to include the plural form, unless the context and/or common sense indicates otherwise.

As used herein, the term “embodiment” refers to an example of the present invention.

It should be understood that where applicable, the phrase “signal” means a signal vector.

It should be understood that when used the word “remote radio head” or “RRH” means one or more devices, such as one or more remote radio heads or RRHs, unless the context or common sense dictates otherwise.

It should be understood that when the description herein describes the use of a “controller”, “signal processing section”, “signal pre-processing section”, “signal capture section”, “signal capture pre-processing section”, “signal visualization section”, “receiving section”, “transceiving section” or “computer” that such a component or device includes one or more processor or processing circuits and stored, specialized instructions for completing associated, described features and functions. Such instructions may be stored in onboard memory or in separate memory devices. Such instructions are designed to integrate specialized functions and features into the controllers, microcontrollers, computing devices, or computer that are used to complete inventive functions, methods and processes related to treating a liquid that contains unwanted material by controlling one or more inventive systems or devices/elements/components used in such a treatment.

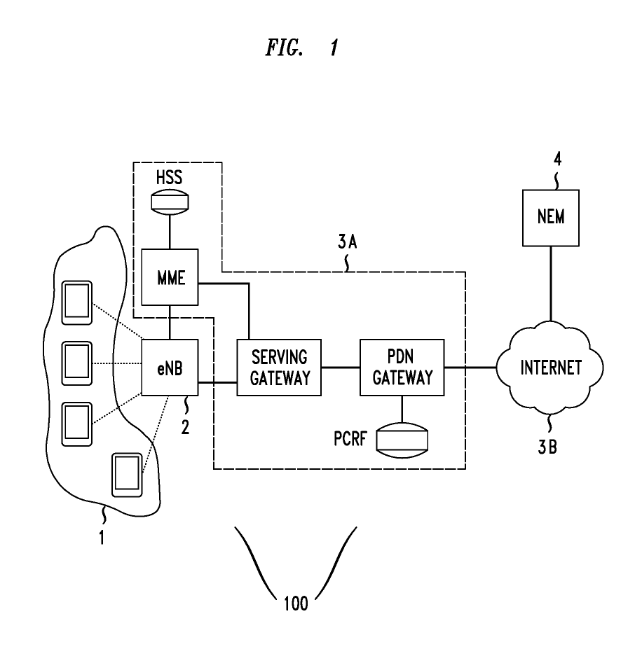

Referring now to FIG. 1 there is depicted an overview of one embodiment of a system 100 for remotely monitoring the RF environment of one or more tower mounted, RRHs 1. As shown, system 100 may be operable to analyze the RF environment surrounding the RRHs 1, as well as the internal operation of the RRHs1. As depicted, the system 100 may comprise a network element management system 4 (“NEM” for short) and one or more RRHs 1 that are operable to communicate with one another over one or more networks, such as a local network 3A (e.g., Long Term Evolution or “LTE” network), and a public network 3B (e.g., the Internet), for example. As depicted the local network 3A may include a mobile management entity (MME), Home Subscriber Server (HSS), Serving Gateway (SGW), Packet Data Network Gateway (PGW) with a Policy and Charging Rules Function (PCRF). Also depicted in FIG. 1 is an evolved Node B (eNB) 2 which functions as a base station for the LTE network 3A and includes a modem for converting analog signals received from the RRHs 1 into digital signals and then transporting (i.e., transmitting and receiving or “transceiving”) such digitized signals to the local network 3A and eventually on to the NEM 4 via network 3B.

Though the NEM 4 and RRHs 1 are shown communicating over an LTE access based network 3A that uses Orthogonal Frequency Division Multiplexing (OFDM) and the Internet 3B, it should be understood that any number of different access based networks may be used to facilitate communications between the NEM 4 and RRHs 1. For example, GSM, TD-SCDMA, WCDMA, and Long Term Evolution-Advanced (LTE-A) access based networks.

Further, though NEM 4 may be located remotely from the RRHs 1, it may also be located close by the RRHs 1 within an equipment room of a base station for example.

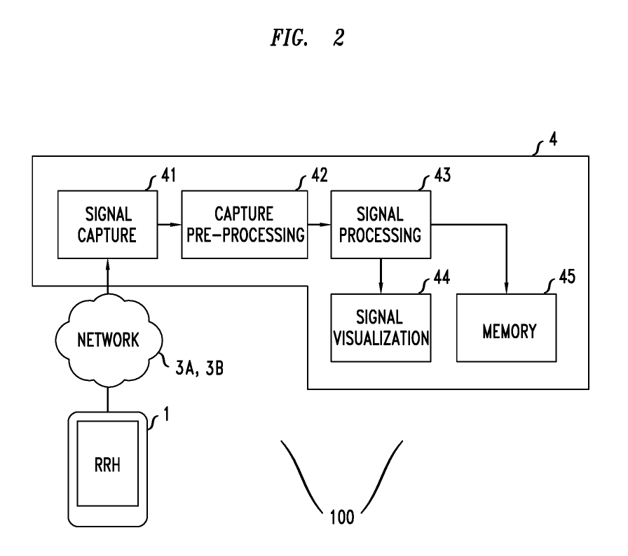

Referring now to FIG. 2 there is depicted another block diagram of an overview of the system 100. As shown, in one embodiment NEM 4 may include a signal capture section 41, a signal capture pre-processing section 42, a signal processing section 43, a signal visualization section 44 and a signal storage or memory section 45 (“memory section”). Though the NEM 4 is depicted as being made up of five components 41 to 45 it should be understood that the number of components may be fewer than five i.e., some may be combined) or more than five (some may be further separated into additional sections). Together, the signal capture section 41 and signal capture pre-processing section 42 maybe referred to hereafter as a “receiving section” 41, 42. Further, in embodiments of the invention, and as described further herein, the functions of signal capturing and pre-processing may be done partly by the RRH (or electronics connected locally to the RRHs) and by the NEM 4 (receiving section 41,42).

In this embodiment, the receiving section 41,42 may be operable to receive multi-dimensional signals (i.e., signals that can be represented as a vector) from the RRHs 1 via eNB 2 and networks 3A,3B. The received signals may comprise information related to signals from the RF environment surrounding (external signals), and including (i.e. internal signals), the RRHs 1.

The signal processing section 43 may be operable to process the received multi-dimensional signals in the time and frequency domains, and to identify one or more RF anomalies from the RF environment at the RRH 1 due to, for example, internal or external interfering signals.

The signal visualization section 44 may include an interface, such as a graphical user interface (GUI) for example, for displaying a visualization of the one or more identified anomalies.

The memory section 45 may comprise one or more electronic memories, such as electronic databases, for storing the received multi-dimensional signals and the results from the signal processing section 43 (e.g., detected anomalies, data used to create the displayed visualizations on the GUI, etc.)

In more detail, the received signals may comprise data representative of the RF environment surrounding, and including, each of the RRHs 1. For example, such data may include RF interference, intermodulation distortion, spectral content, flicker noise, additive white Gaussian noise, colored noise, phase noise, carrier frequency, delay, RF signal strength.

In one embodiment, upon receiving the signals (i.e., data) from the receiving section 41,42, the signal processing section 43 may be operable to detect one or more anomalies within the data by competing one or more processes depending on the type of data received, and/or depending on a set of pre-programmed processes that are input be a user of the NEM 4 and/or depending on a set of processes selected by a user using an interface within section 44, for example.

For example, the processing section 43 may be operable to estimate the spectral content of signals in the RF environment at the RRHs 1 based on the received signals (i.e., vector information within such signals) using a periodic sequence estimation process that can be represented by the sequence estimator relationship:

$${P}_{xx} ( ω ) = \frac{1}{N} {\vert {\sum }_{n = 0}^{N - 1} x ( n ) {e}^{- j ω n} \vert}^{2} . \qquad ( 1 )$$

where x(n) is the signal vector of length N, and e^{-jωk} is the exponential function. The variance of the estimate may be reduced by a weighted window process (i.e., a weighted window power spectral density estimate) given by the following relationships:

Pₓₓ^{ww}(ω)=Σ_{K=-(N-1)}^{N-1}rₓₓ₍ₖ₎ω(k)e^{-jωk} (2)

where ω(k) is a time-domain weighting function and rₓₓ₍ₖ₎ are the coefficients, and e^{-jωk} is the exponential function.

The signal processing section may be further operable to detect an anomaly by identifying one or more acceptable or interfering RF signals, from the RF environment at the RRHs 1, from the received signals (vectors) based on a time and frequency analysis. In an embodiment, such as analysis may include completing a time-frequency (TFR) estimation of a multi-component RF signal using the following relationship:

TFR(t,ω)=Σₖ₌₁^{N}A(t,ω)F(t,ω)+XT (3)

A(t,ω)=2πδ(ω−φₖ(t))*ω (4)

φₖ is the first order derivative of the k^{th} phase law of the e component of the signal, *ω is the spectral convolution operator.

$$F ( t , ω ) = \frac{1}{N} {\sum }_{n = 0}^{N - 1} {e}^{- j ω {Q}_{k} ( t , τ )} {e}^{- \frac{j ω}{N}} \qquad ( 5 )$$

Where τ is the lag used for the computation of the TFR(t,ω) and Qₖ(t,τ) is the function measuring the spreading of the time frequency energy of the e component around its instantaneous frequency law (IFL). It helps in the mono component signal case that it helps to measure the inner interference terms and ideally this tends to zero. XT stands for the cross-terms issued from the combination of the TFRs of each possible combination of components.

In more detail, the processing section 43 may include one or more filter banks that are configured with transfer functions that overlap in frequency. Using such filter banks unwanted artifacts of signal components may be eliminated or ignored. In embodiments, the filter banks may be a combination of electrical circuitry, including processors and memory, that are operable to be controlled using instructions stored as electrical signals within the processing section 43, for example.

In an embodiment, a filter bank structure may be represented by the relationship:

Cₛ={s*hₖ|k=1 . . . N_{filters}} (6)

and

$${h}_{k} = \frac{1}{N} {\sum }_{n = 0}^{N - 1} {e}^{- 2 {π}^{2} {{σ}^{2} ( f - {f}_{k} )}^{2}} {e}^{- \frac{j ω n}{N}} \qquad ( 7 )$$

where hₖ is the summation of the product of the exponential functions for different frequencies and sub-band filters and N_{filters} is related to the number of sub-band filters used.

In addition, a time-frequency analysis may include a sub-band analysis for identifying structures of the received signals for extracting specific information related to the analysis.

The signal processing section 43 may be further operable to detect an anomaly by identifying one or more RF carriers, and each identified carrier's access scheme (e.g., OFDMA, CDMA, TDMA) in the RF environment at the RRHs 1 from the received signals (vectors within) based on power and frequency estimates of each identified carrier.

Still further, the signal processing section 43 may be operable to detect an anomaly by estimating the spectral coherence of signals in the RF environment at the RRHs 1 from the received signals (vectors within). Such an estimate helps determine the quality of the frequency response of the captured signal (i.e., signal vector) due to interfering signals at the RRHs 1. In an embodiment, the spectral coherence can be computed using the following relationships:

$${C}_{xy} ( f ) = \frac{\vert \overline{{S}_{xy}} ( f ) \vert}{\overline{{S}_{xx}} ( f ) * \overline{{S}_{yy}} ( f )} . \qquad ( 8 )$$

where S̅_̅{̅x̅y̅}̅ (f) is the mean of the two sided spectral density in its complex form given two signal vectors x and y, S̅ₓ̅ₓ̅(f) and S̅_̅{̅y̅y̅}̅ (f) are the mean of the two sided spectral density of signals x and y, respectively, in its complex form.

In additional embodiments, the signal processing section 43 may be further operable to detect an anomaly by estimating the spectral density of signals in the RF environment at the RRHs 1 from the received signals (again, vector information within such signals).

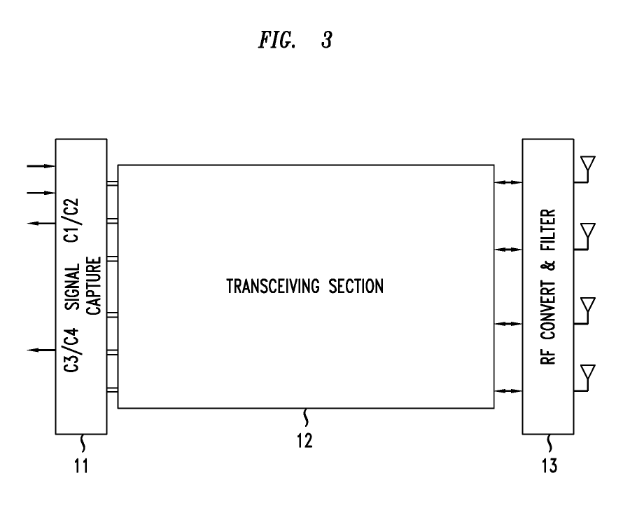

Referring now to FIG. 3 there is depicted a simplified block diagram of components of the system 100 that may be a part of the RRHs 1, or located locally (i.e., located close by and connected) to the RRHs 1. As shown, the system 100 may include an RF conversion and filter section 13 at the RRHs 1 operable to, among other things, down convert the over the air, analog signals received by each RRH 1 from 400 MHz-6 GHz, for example, sample such downconverted signals and convert the sampled signals into digital versions that includes both real and imaginary (from a mathematical representation; it is all real world information) parts of each downconverted signal to form a vector representation of such signals.

The system 100 at the RRHs 1 (i.e., located at, or nearby the RRHs 1) may further include a signal capture section 11 operable to capture the digitized signals and pre-process the vector information within such signals for data transfer, information extraction and eventual analysis by the NEM 4.

The system 100 at the RRHs 1 may also include a transceiving section 12 operable to transmit and receive digital signals) to, and from, the NEM 4 via networks 3A,3B, for example.

Having presented overviews of embodiments of the invention, the inventor now provides a more detailed discussion.

Referring back to FIG. 2, the signal capture section 41 is shown. In an embodiment, this section 41 may be operable to detect digitized and formatted phase information (e.g., data) from within the signals received from the RRHs 1 and assemble the phase data into a structure that allows for the processing of the data by detecting if the signal is a complex signal (real and imaginary components) or a real signal. After assembling the required structure, the so assembled information to the signal capture, pre-processing section 42 for further processing.

Upon receiving the assembled information, the pre-processing section 42 may be operable to apply smoothing techniques to refine the information before it is sent to the signal processing section 43 for modeling and analysis. The pre-processing section 42 may shape the information using a selection of filters (electronic or a combination of electronic and firmware based filters) of various bandwidths, where a filter may be pre-selected or selected by a user based on the type of RRH that originally sent the information to the NEM 4 (e.g., Band 25 or 1930 to 1995 MHz (transmit only), (1850 to 1915 MHz (receive only), Band 25 external interference (transmit/receive)).

Continuing, the pre-processed information is then sent to the signal processing section 43. As noted above, the signal processing section 43 may be operable to process the received multi-dimensional signals in the time and frequency domains, and to identify one or more RF anomalies from the RF environment at the RRHs 1 due to, for example, internal or external interfering signals.

The inventor now provides a more detailed discussion of processes that may be executed by the signal processing section 43 to identify a number of different RF anomalies.

In general, the signal processing section 43 is operable to execute instructions stored in a memory (or memories) as electrical signals, where the instructions represent predictive, real world functions that identify relationships among variables and evaluate variables based on other variables with some residual error in accuracy. In a predictive based process (or method),

Y=αX+β+e (9)

where Y is a function X, and where α and β minimize the error when Y is predicted for a given range of values of X. In embodiments of the invention, analytical models were invented based on such criteria that are descriptive of a signal to be analyzed to communicate results.

In an embodiment, the signal processing section 43 may be operable to analyze the spectral characteristics of the signals received from RRHs1 using spectral estimation processes.

For example, one process involves executing instructions stored in memory as electrical signals that represents a spectral estimation process that uses a Discrete Fourier transform (DFT) or Fast Fourier Transform (FFT) and an estimate of the autocorrelation function (ACF).

More particularly, spectral estimates may be computed using either a periodic sequence processor a “weighted window” process by the section 43. It should be understood that either one of two processes may be used sequentially or in parallel.

In an embodiment, a weighted window process applies windowing functions to an estimated autocorrelation function to reduce the variance in spectral estimates.

The periodic sequence process estimates the power spectral density of a received signal (or signals) by computing the magnitude squared Fourier transform of a finite length realization of a random process. In an embodiment, estimates using the periodic sequence process can make use of the following relationships:

$${P}_{xx} ( ω ) = \frac{1}{N} {\vert {\sum }_{n = 0}^{N - 1} x ( n ) {e}^{- j ω n} \vert}^{2}$$

which is the same relationship as relationship (1) discussed previously herein. The variance of the estimation from (1) does not approach zero as the number of signal samples increases, however, the variance of the sequence is approximately,

Var(Pₓₓ(ω))≈(Pₓₓ(ω))² (10)

This variance in the estimate can be reduced by averaging the periodic sequences generated from M non-overlapping, independent and identically distributed finite realizations of the random process, where the averaged periodic sequences can be expressed as,

$${{P}_{xx} ( ω )}_{average} = \frac{1}{M} {\sum }_{m = 1}^{M} {( {P}_{xx} ( ω ) )}^{m} \qquad ( 11 )$$

The inventor discovered that the variance of an average periodic sequence estimation using the process described above and herein, may be reduced by a factor of M when compared to existing periodic sequence estimations.

As noted above, rather than use the periodic sequence estimation process, in an alternative embodiment a weighted window process may be used to estimate spectral characteristics. That said, both processes may be used in a preferred embodiment.

Accordingly, the processing section 43 may be operable to execute stored instructions stored in a memory (or memories) as electrical signals to complete a weighted window estimation process that uses “data windowing” in order to reduce the variance of spectral estimates through data windowing. Such a process can be represented by the following relationships:

Pₓₓ^{ww}(ω)=Σ_{k=-(N-1)}^{N-1}rₓₓ₍ₖ₎ω(k)e^{-jωk}

which is the same relationship as relationship (2) discussed previously herein, where ω(k) is a time-domain weighting function (“weighting function”). The processing section 43 may be operable to apply the weighting function to the pre-processed signals in order to reduce the variation in the latter lags of an estimated autocorrelation sequence, where it should be understood that lags are not known a priori, and thus need to be estimated. The process is assumed to be wide sense stationary and the autocorrelation matrix is a conjugate symmetric (Hermitian) because

rₓₓ(k)=E{xₙ₊ₖx*ₙ} (12)

Where rₓₓ (k) are the autocorrelation coefficients, and xₙ is the signal vector.

Because the latter lags are estimated using fewer and fewer samples, the application of the weighting function to pre-processed signals has the effect of reducing the variance of the spectral estimates that result from the weighted window estimation, whose variance is approximately,

$$Var ( {P}_{xx}^{ww} ( ω ) ) \approx \frac{{( {P}_{xx} ( ω ) )}^{2}}{N} {\sum }_{k = - N}^{N} {ω}^{2} ( k ) \qquad ( 13 )$$

In an additional embodiment, an additional bias may be imposed due to a corresponding convolution process that occurs in the frequency domain due to the windowing process.

A “tapering” process may be applied to the estimates by the processing section 43. Tapering may be applied to improve the statistical properties of spectral estimates.

A time series used in spectral analysis is regarded as a finite sample of an infinitely long series. In an embodiment, the properties of the infinitely long series may be inferred from the finite sample.

In an embodiment, the processing section 43 may be operable to execute stored instructions stored in a memory (or memories) as electrical signals to complete a tapering process. More particularly, to complete a process whereby the ends of a mean-adjusted time series may be altered so that the ends (i.e., the last signal samples or estimates) “taper” gradually down to zero. In an embodiment, as a preliminary process, the mean estimate of the sampled signal may be subtracted from spectral estimates so that the series has mean zero. A mathematical taper may be appliedbased on the following relationship:

$${w}_{p} ( t ) = \{ \begin{matrix}\frac{1}{2} \{ 1 - cos 2 π t / p ) , & 0 \leq t < p / 2 \\ 1 , & p / 2 \leq t < 1 - p / 2 \\ \frac{1}{2} \{ 1 - cos 2 π ( 1 - t ) / p \} , & 1 - p / 2 \leq t < 1\end{matrix} \qquad ( 14 )$$

where p is the proportion of data desired to be tapered, t is the time index, and wₚ(t) are the taper weights.

In additional embodiments, the processing section 43 may be operable to execute stored instructions stored in a memory (or memories) as electrical signals to complete as signal stability process that uses cross validation (e.g., by splitting the information corresponding to the received, pre-processed signals into segments and checking to see if the analysis across the various signal segments holds (i.e., if the tapering weights are appropriate), Still further, the processing section 43 may be operable to execute stored instructions stored in a memory (or memories) as electrical signals to complete a sensitivity process to study the behavior of a model when global parameters are varied (i.e., change the parameters of the model based on the obtained results).

The signal processing section 43 may be further operable to execute stored instructions stored in a memory (or memories) as electrical signals to complete a process of detecting an anomaly by identifying one or more acceptable or interfering RF signals, from the RF environment at the RRHs 1, from the received signals based on a time and frequency (“TFR”) analysis.

In a general case any multi-component RF signal represented by,

s(t)=Σₖ₌₁^{N}Aₖe^{jØ}^{ₖ}^{(t)} (15)

in time frequency (i.e., a simultaneous analysis in the time and frequency domains) can be represented as:

TFR(t,ω)=Σₖ₌₁^{N}A(t,ω)F(t,ω)+XT

which is the same as relationship (3) above, where

A(t,ω)=2πδ(ω−φₖ(t))*ω

which is the same relationship as (4) above, where, again, φₖ is the first order derivative of the phase law of the k^{th} component of the signal, and *ω is the spectral convolution operator, and where

$$F ( t , ω ) = \frac{1}{N} {\sum }_{n = 0}^{N - 1} {e}^{- j ω {Q}_{k} ( t , τ )} {e}^{- \frac{j ω n}{N}}$$

which is the same as relationship (5) above, where, again τ is the lag used for the computation of TFR(t,ω), Qₖ(t,τ) is the function measuring the spreading of the time frequency energy of the k^{th} component around its instantaneous frequency law (IFL). It helps in the mono component signal case to measure the inner interference terms and ideally this tends to zero. XT stands for the cross-terms issued from the combination of the TFRs of each possible combination of components.

In embodiments, in order to analyze an unknown, generally non-stationary, multi-component signal(s) from the RRHs 1 containing noise or other interference, the processing section 43 may be operable to execute stored instructions stored in a memory (or memories) as electrical signals to complete a TFR analysis process.

In an embodiment of the invention, in order to avoid unwanted signal component artifacts, the processing section 43 may be operable to execute stored instructions stored in a memory (or memories) as electrical signals to complete the functions and related processes of a filter-bank whose transfer functions are overlapped in frequency. Such a filter bank can be represented by the following relationship:

Cₛ={s*hₖ|k=1 . . . N_{filters}}

which is the same as relationship (6) set forth previously herein, and where hₖ can be represented by relationship (7) above, namely:

$${h}_{k} = \frac{1}{N} {\sum }_{n = 0}^{N - 1} {e}^{- 2 {π}^{2} {{σ}^{2} ( f - {f}_{k} )}^{2}} {e}^{- \frac{j ω n}{N}}$$

In embodiments of the invention, signals received from RRHs 1 may, generally speaking, have a complex time-frequency structure. However, their representative complexity is reduced by using several sub-bands. That is to say, in one embodiment the processing section 43 may be operable to execute stored instructions stored in a memory (or memories) as electrical signals to complete a process of analyzing the sub-bands of a given signal received from an RRH 1 and signals around its neighborhood (i.e., from other operating frequency bands) in order to identify the time-frequency structure of a signal much easier than having to complete analysis of the entire time frequency domain.

In an embodiment, a local energy criterion may be used as an identifying criteria to depict time-frequency structures whose energy is higher than a local threshold.

The signal processing section 43 may be further operable to complete power versus frequency estimates to detect an anomaly. In more detail, processing section 43 may be operable to execute stored instructions stored in a memory (or memories) as electrical signals to complete a process of detecting an anomaly by identifying one or more RF carriers, and each identified carrier's access scheme (e.g., OFDMA, CDMA, TDMA) in the RF environment at the RRHs 1 from the received signals (vectors within) based on power and frequency estimates of each identified carrier.

In an embodiment he processing section 43 may be operable to execute stored instructions stored in a memory (or memories) as electrical signals to complete a high resolution, estimation process of the actual frequency of a discrete frequency component of a signal received from RRHs 1 by applying a Fourier Transform to information within the signal, and performing a weighted average of the frequencies around a detected peak in the signal's power spectrum.

P_{wa}=Σᵢ₌ₖ₋₁^{k+1}Pᵢ*i*Δ_{f} (16)

Pₛᵤₘ=Σᵢ₌ₖ₋₁^{k+1}Pᵢ (17)

where Pi is the power, and Δ_f=F_s/N,

and

$${F}_{est} = \frac{{P}_{wa}}{{P}_{sum}}$$

In an embodiment, processing section 43 may be operable to execute stored instructions stored in a memory (or memories) as electrical signals to complete a process of estimating the power in Vₘₛ² of a given peak discrete frequency of a signal from an RRH 1. In an embodiment, such as estimate may be computed by the summation of the power in the bins around the peak:

$$\begin{matrix}{P}_{sum} = {\sum }_{i = k - 1}^{k + 1} {P}_{i} & ( 18 ) \\ {P}_{est} = \frac{{P}_{sum}}{{P}_{noise}} & ( 19 )\end{matrix}$$

where Pₙₒᵢₛₑ is P the total noise power in the window bandwidth.

The signal processing section 43 may be operable to execute stored instructions stored in a memory (or memories) as electrical signals to complete a process of detecting an anomaly by estimating the spectral coherence of signals in the RF environment at the RRHs 1 from signals received from the RRHs 1. Such an estimate helps determine the frequency response of a captured signal (signal vector) due to interfering signals at the RRHs 1.

In an embodiment, such a process begins by realizing given two signals x and y the processing section 43 may compute a two sided spectra in its complex form represented by:

$${B}_{xy} ( f ) = ( {\sum }_{n = 0}^{N - 1} {x}_{n} {e}^{- \frac{j 2 π kn}{N}} ) * ( {\sum }_{n = 0}^{N - 1} {y}_{n} {e}^{- \frac{j 2 π kn}{N}} ) \qquad ( 20 )$$

where k=1 . . . N−1, and the cross spectrum spectral coherence maybe represented as:

$${S}_{xy} ( f ) = \frac{{B}_{xy} ( f )}{{N}^{2}} \qquad ( 21 )$$

In an embodiment, the signal processing section 43 may be operable to execute stored instructions stored in a memory (or memories) as electrical signals to complete a process of computing the frequency response H(f), which gives the gain and phase versus the frequency of the system (e.g., RRH 1). The frequency response may be represented by the following relationship:

$$\begin{matrix}H ( f ) = \frac{{S}_{xy} ( f )}{{S}_{xx} ( f )} & ( 22 ) \\ and & \\ {B}_{xx} ( f ) = ( {\sum }_{n = 0}^{N - 1} {x}_{n} {e}^{- \frac{j 2 π kn}{N}} ) * ( {\sum }_{n = 0}^{N - 1} {x}_{n} {e}^{- \frac{j 2 π kn}{N}} ) & ( 23 )\end{matrix}$$

where k=1 . . . N−1 and the auto-correlated, spectrum spectral coherence may be represented by the following relationship:

$${S}_{xx} ( f ) = \frac{{B}_{xx} ( f )}{{N}^{2}} \qquad ( 24 )$$

The signal processing section 43 may be operable to execute stored instructions stored in a memory (or memories) as electrical signals to complete a process of computing the time response of the signal (i.e., signal vector) that can be represented by the relationship:

$$h ( t ) = \frac{1}{N} {\sum }_{n = 0}^{N - 1} {( \frac{{S}_{xy} ( f )}{{S}_{xx} ( f )} )}_{n} {e}^{\frac{j 2 π kn}{N}} \qquad ( 24 )$$

In order to determine the quality of the frequency response of a signal (i.e., signal vector) and how much of the energy is correlated with another signal, such as a transmitted signal (from other RRHs), excessive noise or interference, the signal processing section 43 may be operable to execute stored instructions stored in a memory (or memories) as electrical signals to complete a process of computing the spectral coherence of the signal (signal vector) under analysis, C_{xy}(f). The spectral coherence may be represented by the following relationship:

$${C}_{xy} ( f ) = \frac{{\vert \overline{{S}_{xy}} ( f ) \vert}^{2}}{\overline{{S}_{xx}} ( f ) * \overline{{S}_{yy}} ( f )}$$

Which is relationship (6) discussed previously herein.

In an embodiment of the invention, the signal processing section 43 may be operable to execute stored instructions stored in a memory (or memories) as electrical signals to complete processes related to performance metrics.

More specifically, the processing section 43 may be operable to compute an error vector which is a measurement of the difference between a reference waveform R and a received signal vector having a waveform M. In embodiments, the processing section 43 may be operable to correct the measured waveform by sampling the timing offset and RF frequency offset after which the carrier leakage may be removed from the measured waveform. The processing section 43 may be further operable to modify the measured waveform by selecting the absolute phase and absolute amplitude of the signal.

The signal processing section 43 may be operable to execute stored instructions stored in a memory (or memories) as electrical signals to complete processes related to computing the magnitude of the error vector as percentage or in dB.

Such a magnitude may be represented by the following relationships:

$$\begin{matrix}{M}_{ev} ( \% ) = \sqrt{\frac{{\sum }_{i = 0}^{N - 1} {\vert {R}_{i} - {M}_{i} \vert}^{2}}{{\sum }_{i = 0}^{N - 1} {\vert {R}_{i} \vert}^{2}}} * 100 \% & ( 25 ) \\ {M}_{ev} ( dB ) = 10 * {log}_{10} ( \sqrt{\frac{{\sum }_{i = 0}^{N - 1} {\vert {R}_{i} - {M}_{i} \vert}^{2}}{{\sum }_{i = 0}^{N - 1} {\vert {R}_{i} \vert}^{2}}} ) & ( 26 )\end{matrix}$$

It is difficult to quantify the characteristics of a signal from an RRH 1 to be analyzed because of its inherent randomness and inconsistencies. Useful information from a noise-like signal may be extracted, by a statistical description of the power levels in this signal, and a distribution function curve is computed which shows how much time the signal spends at or above a given power level. The power level may be expressed in dB relative to the average power. The percentage of time the signal spends at or above each line defines the probability for that particular power level. Accordingly, the signal processing section 43 may be operable to execute stored instructions stored in a memory (or memories) as electrical signals to complete processes related to completing processes related to extracting noise-like signals, computing a distribution function curve where power level may be expressed in dB relative to the average power, and computing the percentage of time the signal spends at or above each line to define the probability for that particular power level.

In addition to the processing section 43, the NEM 4 also comprises a signal visualization section 44 and a memory section 45.

In embodiments of the invention, signal visualization techniques the visualization section may include a GUI and other capabilities for clearly and efficiently communicating messages to a user of the NEM 4. The GUI may be operable to generate and display spectral graphs, tables and charts to help communicate key characteristics contained in the signals received from the RRHs 1. Tables may also be generated and displayed to assist the user in referencing specific numbers. Charts may be generated and displayed to explain the quantitative characteristics contained in signals received from the RRHs.

Once information (data) has been analyzed by other components of the NEM 4, the information may be communicated to the user of the NEM 4 in many formats to support the user's requirements and stored by the memory section 45 in suitable format for additional analysis.

Referring now to FIG. 3 there is depicted a simplified block diagram of an RRH 1 according to an embodiment. As depicted the RRH 1 comprises a signal capture section 11, transceiving section 12, an RF conversion and filter section 13 and one or more antennas 14.

In one embodiment, the RF conversion and filter section 13 may be operable to down convert the over-the-air RF signals into digital signals (vectors), the signal capture section 11 may be operable to capture the down converted digital signal and preprocess the signal, while the transceiving section 12 may be operable to transmit the preprocessed signals from the RRH 1 to the NEM 4 (not shown in FIG. 3) over a network. In an embodiment, the signal capture section 11 may comprise a field-programmable gate array (FPGA).

In an embodiment, the NEM 4 may be operable to forward a port enable message to a respective port in the RRH 1. Upon receipt of the message, the respective circuitry associated with the enabled port of the RRH 1 will be activated to send digitized signals related to the RF environment surrounding the RRH1 and its internal operation to the NEM 4. Though the RRH 1 may have 4 or more ports, only the port and its associated circuitry which receives the message will be activated to send digitized signals to the NEM 4.

Referring now to the operation of an exemplary NEM 4, in one embodiment upon power up a NEM 4 may be operable to operate in a streaming mode. In an embodiment, the visualization section 44 may be operable to generate and display a streaming capture mode configuration data screen for review by the user. The user may input destination RFM information and desired capture parameters to initiate the RF streaming capture function. It should be understood by “RFM information” is meant information that identifies the hardware, control unit, power amplifier sections, and transceiving sections 12 for each port of an RRH, for example.

The NEM 4 may, thereafter, be operable to send a port enable message to the RRH 1 based on the RFM information and desired capture parameters.

In an embodiment, an exemplary port enable message may comprise the following:

Identification of the radio and antenna path along with capture settings

IP address and UDP port number of the streaming target port, RRH)

Configuration Parameters

License Check

In an embodiment, upon receiving the message from the NEM 4, the transceiving section 12 (e.g., a baseband unit within the section 12) may be operable to forward a response such as, “request understood” or “license activation error”, where the former initiates the forwarding of signals from the RRH 1 to the NEM 4 while the latter does not.

Thereafter, the NEM 4 and RRH 1 may be operable to set up a UDP streaming channel that configures a UDP/IP layer

In an embodiment, the transceiving section 12 (e.g., a baseband unit) or another section within the RRH 1 may be operable to request a streaming mode capture from the RFM using a message, whereupon an IP address and UDP port number are provided by a baseband unitand the transceiving section 12 or other section of the RRH 1 returns an “request executed” message to the NEM 4 along with RFM attributes as a response.

In an embodiment, the transceiving section 12 is operable to start streaming capture packets to the NEM 4 using UDP as a transport protocol and starts a 10 minute timer, for example. The transceiving section 12 (e.g., baseband unit) may forward the UDP packets (keeping the payload unmodified) to the NEM 4.

The transceiving section 12 is operable to split the data within a single capture stream into multiple UDP packets with a maximum size of 1044 bytes. This is needed to avoid packet fragmentation on IP level (issues with some operator's OAM network configurations). The transceiving section 12 may be operable to send the packets, making up one capture stream, to the NEM 4 at a rate of no less than that required by the NEM 4 graphical refresh rate, for example 32 kbit/sec to meet a 1-second graphical refresh rate.

As discussed briefly above data is transferred between the RH 1 and NEM 4 using UDP packets. In an embodiment, the transfer of data using UDP packets enables the capture of uplink and downlink I/Q samples for use in RF spectral analysis. One I/Q sample consists of 16 bits I and 16 bits Q of data. The IQ data originate before conversion from a base band signal within the transceiving section 12 into the actual transmission band in the transceiving section 12 and after conversion from the transmission band to the base band in the transceiving section 12. I/Q data captures may be used by the NEM 4 to generate a spectral view of the received or transmitted signal on a selected antenna port.

As it is not possible to send the full IQ data stream to the NEM 4 doing the spectral analysis, captures may be taken periodically and sent to the NEM 4. Each such capture consists of a number of consecutive IQ data samples. The number of samples within a single capture is given by the following relationship:

CaptureSize DATACAP: CAPDURATION*RF HEADDESC:ADCSAMPLERATE (or DACSAMPLERATE)*0.001

Such a single capture may be sent to the NEM 4 within a number of UDP packets (called “fragments” below). The capture protocol limits the UDP payload size to 1044 octets. The capture protocol header is 20 octets in length. The maximum number of samples within a fragment is therefore:

MaxSamplesInFragment=(1044−20)/4=256;

And the number of fragments needed for a single capture is:

Number Fragments=ceiling(CaptureSize/256);

Captures may be repeated periodically with an interval of DATACAP:CAPINT. The fragments of a single capture may not be sent in a single batch but are transmitted in equally spaced intervals given by:

FragmentTransmissionInterval=DATACAP:CAPINT/NumberFragments;(suitably rounded down,approximate value sufficient)

This transmission process helps to avoid congestion in the backhaul network (e.g., networks 3A, 3B or another network). UDP protocol was chosen for transport as it incurs minimum overhead and is suitable for continuous streaming of data. UDP, however, does not provide assured, in-order delivery.

Accordingly, in an embodiment the signal the receiving section 41,42 of the NEM 4 must be operable to:
provide fragment reassembly functionality
provide fragment reordering (typically part of fragment reassembly)
tolerate fragment loss

All fragments will have between 1 and MaxSamplesInFragment samples. Accordingly, in one embodiment the total number of samples per capture may be spread substantially equally between the fragments.

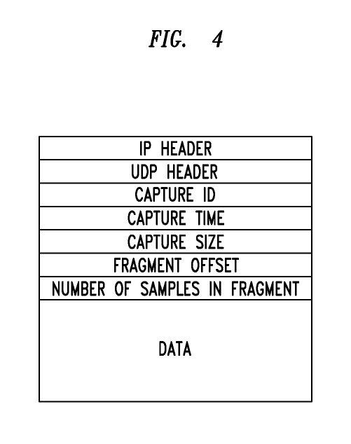

FIG. 4 illustrates an exemplary UDP packet format for a single fragment.

Referring to FIG. 4, the application header information is as follows (all fields are 4 octets and in network byte order):
Capture ID—unique identifier for this capture, provided by DATACAP: CAP ID
Capture Time—relative time in seconds since start of the capture sequence (this will be the same for all fragments belonging to the same capture)
Capture Size—size of capture in samples
Fragment offset—fragment offset in number of samples, this is the number of the first sample in this fragment. The numbering starts at zero.
Number of Samples in Fragment—(FS(i))—total number of samples in fragment #i
Data—contains the captured samples. Each sample is 4 octets in length, the first 2 octets contain I value, the last 2 octets the Q value, both in MSB bit ordering. The values are in two's complement representation. (If the natural IQ values of an RFM have less than 16 bit, they are sign-extended to 16 bits to maintain two's complement representation. If the IQ values in the RFM have more than 16 bit, the least significant bit gets truncated).

Within the UDP header, it is important to note that the Source Port ID must be hard-coded by the RRH 1, where an exemplary number is number is 8,111. The Destination Port ID is specified by the NEM 4.

In an embodiment, data capture for RF spectral imaging is initiated by the NEM 4 by sending the ARD attribute Data Capture (DATACAP) with the required fields. This attribute is used to initiate the capture and streaming of digital IF samples corresponding to either a transmit or receive path of the RRH 1. The RRH's 1 ability to support these types of captures is indicated by the RFHEADDESC attribute. Once the DATACAP action is enabled, the RRH 1, will start a 10 minute timer, for example, if no new DATACAP attribute has been received during the next 10 minutes, the capture and streaming will terminate. The data fields that may be used are the following.
STATE (STATE) indicates if streaming of captured data is enabled or disabled. If enabled, upon
receipt of STATE:DISABLE, the streaming operation will be terminated.
Antenna Port (ANTPORT) indicates the RF Path within the RTU associated with the capture
Capture Duration (CAPDURATION) indicates the duration of the sampling period.
Capture Type (CAPTYPE) indicates the type of capture. From the transmit side (post PA), employing the RRH's 1 sampling receiver, TXCAP is used. For the receive (uplink) side, RXCAP is used.
UDP Server Address (ADDR)—the target IP address to which the capture data is streamed.
UDP Destination Port (PORT)—the target UDP port to which the capture data is streamed.
Capture ID (CAPID)—Number to allow the capture processing entities outside the RTU to distinguish between different captures.
Capture Interval (CAPINT)—Time between each successive capture. If datafield not sent, default value is implemented.
Super Frame Number (SFN) is optional and is only used if the start of capture needs to be synchronized to an LTE superframe.

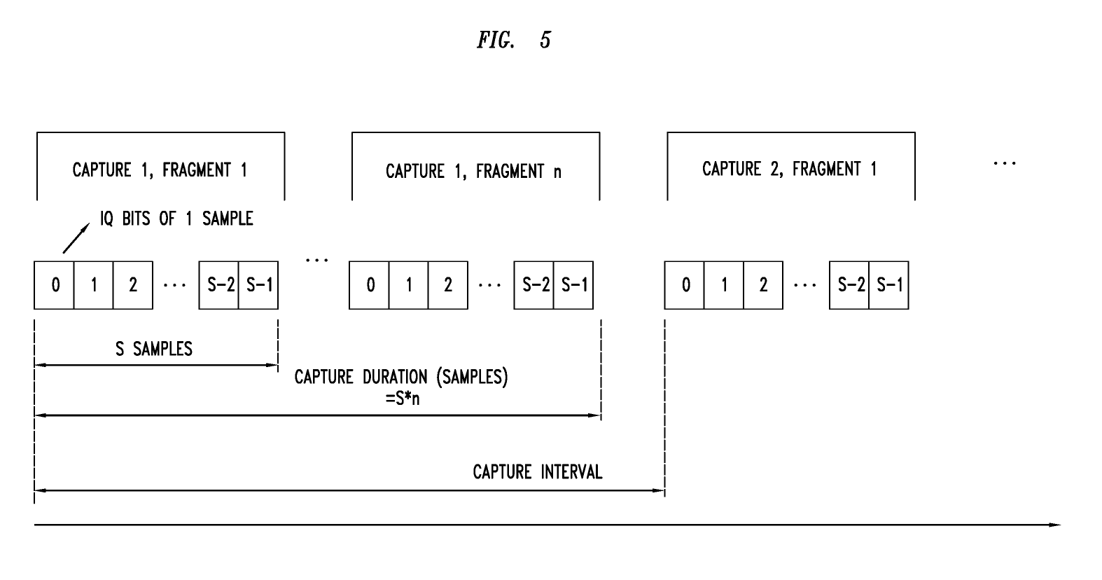

In an embodiment, after the DATACAP attribute is parsed the i/Q capture sequence shown in FIG. 5 may be initiated.

In an embodiment, a Fragment Offset may be used to detect the last fragment in the capture by ((Fragment Offset+Number of Samples in Fragment)>=Capture Size). There is a continuous stream of data contained both within the capture sequence and within an individual capture, which is separated if necessary into equally spaced fragments. The capture interval is defined as the time between captures, with a range of one to ten seconds as specified by DATACAP: CAP INT.

In an embodiment, the capture sequence ends when the DATACAP action is terminated by the NEM 4, times out or is otherwise stopped. If it times out there will be an alarm sent. Any processor overload conditions may temporarily suspend data streaming, as this streaming capability must not degrade system performance.

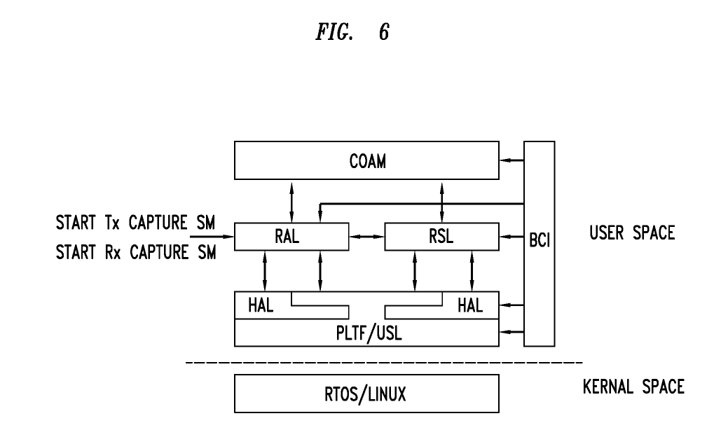

The signal (spectral) capture section 11 of the RRH 1 may be operable to execute instructions stored in a memory (or memories) as electrical signals to complete spectral capture of signals within RRH 1. In one embodiment the spectral capture of signals within RRH 1 may be modeled as shown in FIG. 6.

As shown in the model in FIG. 6, SACAPT currently exists for data captures on the receive ports. The class related to this subsystem is SACapture which is to be extended adding new methods required for the streaming mode capture and the transport of the captured data to the target BBU using the specified IP address and the defined UDP port.

Upon receiving a message (e.g. ARD message) at the RRH 1 the attribute is parsed and the corresponding data fields are extracted to indicate if it is a data capture request for Transmit port or Receive port and the duration of the capture.

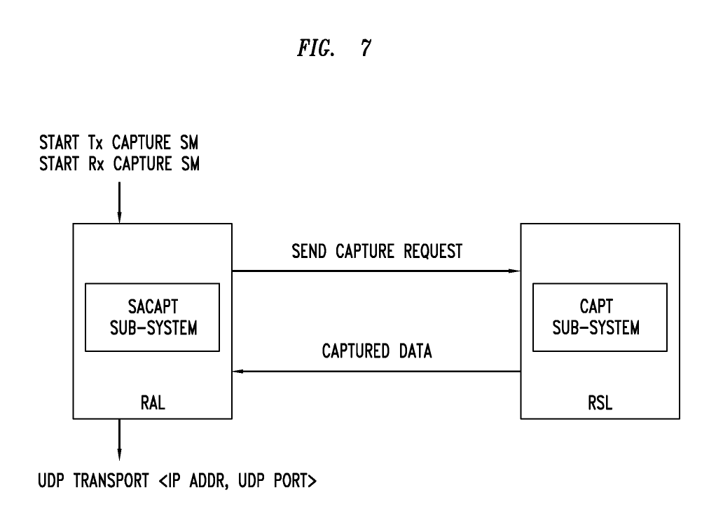

FIG. 7 depicts a more detailed model for a data capture model according to an embodiment of the invention.

As depicted, if data capture is for the Tx port then startTxCaptureSM for capturing data in streaming mode, buffer size equivalent of 10 ms of capture at sampling rate of 307.2 MHz, for example, is allocated and depending on the duration of the capture, 10 ms captures are done the required number of times. Once the 10 ms capture is done the data is decimated by 2 to maintain the same sampling rate as the receive (e.g., 153.6 MHz). The data is then broken down to packets of the 1044 bytes or octets in the packet format discussed elsewhere herein. The resulting 296 samples of I/Q data may be transported to the specified UDP port by calling UDPTansport.

Similarly, if the data capture is for the Rx port the startRxCaptureSM for capturing data in streaming mode, buffer size equivalent to 10 ms of capture at sampling rate of 153.6 MHz is allocated and depending on the duration of the capture, 10 ms captures are done the required number of times.

Respective buffers for the Tx data capture and the Rx data capture need to be allocated and released upon completion, also related timers and counters need to be set for the duration and the number of data fragments. Flags need to be defined and set accordingly to ensure that at any given time only one capture for either transmit or receive for the corresponding ports is supported and while the data capture is in progress no other request for capture will be supported.

To summarize, an exemplary data capture process may include the following:
Capture the Tx/Rx data on specified Tx/Rx Port (0, 1, 2, 3) into the SDRAM2
Sample rate for Tx is 307.2 MSamples/s and for Rx is 153.6 MSamples/s
In the case of Tx decimate the data rate to 153.6 MSamples/s
Duration of capture is 10 ms at the sample rate (6144000 bytes)/capture
Store the SDRAM2 data into a buffer allocated for Tx or Rx capture
Transfer the data from the buffer to the BBU by UDP/IP using the packet format

In an embodiment, a control and management platform or “plane” (C & M) Layer 2 protocol may be an Ethernet platform or plane which is used for the transfer of captured data. Each of the radio frames may consist of 192 hyperframes and each hyperframe may consist of 256 control words. C & M data may be multiplexed onto a specific subset (sub-channel) of control words. The 256 control words of the hyperframe may be organized into 4 segments referred to as sub-channel and therefore there are 64 sub-channels, where sub-channels 0-28 may be used for comma byte, synchronization/timing, slow C & M/HDLC layer 2 protocol, protocol version and vendor specific data. Some of the sub-channels may bee reserved for future use. Sub-channels 29-63 can be used for Ethernet (e.g., a fast C & M link).

It should be apparent that the foregoing describes only selected embodiments of the invention. Numerous changes and modifications may be made to the embodiments disclosed herein without departing from the general spirit and scope of the invention.

What is claimed is:

1. A system for analyzing the operation of a radio frequency (RF) remote radio head comprising:
a first receiving section operable to receive signals from a tower mounted, remote radio head (RRH), the signals comprising information related to signals from an RF environment at the RRH;
a signal processing section operable to process the received signals in the time and frequency domains, and to identify one or more anomalies due to internal or external interfering signals from the RF environment at the RRH; and
an interface for displaying a visualization of the one or more anomalies.

2. The system as in claim 1 wherein the received signals comprise one or more of the following types of data: RF interference, intermodulation distortion, spectral content, flicker noise, additive white Gaussian noise, colored noise, phase noise, carrier frequency, delay, RF signal strength.

3. The system as in claim 1 wherein the signal processing section is further operable to detect an anomaly by estimating the spectral content of the signals in the RF environment at the RRH based on the received signals.

4. The system as in claim 3, wherein the signal processing section further comprises a periodic sequence estimator for estimating spectral content, the periodic sequence estimator represented by the relationship:
$${P}_{xx} ( ω ) = \frac{1}{N} {\vert {\sum }_{n = 0}^{N - 1} x ( n ) {e}^{- j ω n} \vert}^{2}$$

5. The system as in claim 4, wherein signal processing section further comprises a weighted window power density estimator for reducing a variance of the estimate, where the weighted window power spectral density estimator is reoriented by the relationship:
$${P}_{xx}^{ww} ( ω ) = {\sum }_{k = - ( N - 1 )}^{N - 1} {r}_{xx ( k )} ω ( k ) {e}^{- j ω k}$$

6. The system as in claim 1 wherein the signal processing section is further operable to detect an anomaly by identifying one or more acceptable or interfering RF signals in the RF environment at the RRH from the received signals based on a time and frequency analysis.

7. The system as in claim 6, wherein the signal processing section is further operable to complete time and frequency estimates of a multicomponent RF signal using the following relationship:
$$TFR ( t , ω ) = {\sum }_{k = 1}^{N} A ( t , ω ) F ( t , ω ) + XT$$

8. The system as in claim 7, wherein the signal processing section further comprises filter banks with transfer functions overlapped in frequency to avoid signal component artifacts.

9. The system as in claim 8, wherein a filter bank structure is represented by the relationship:
Cₛ={s*hₖ|k=1 . . . N_{filters}}

10. The system as in claim 9, wherein the signal processing section is further operable to complete a sub band analysis process to identify signal structures.

11. The system as in claim 1 wherein the signal processing section is further operable to detect an anomaly by identifying one or more RF carriers, and each identified carrier's access scheme, in the RF environment at the RRH from the received signal vectors based on power and frequency estimates of each identified carrier.

12. The system as in claim 1 wherein the signal processing section is further operable to detect an anomaly by estimating the spectral coherence of the signals in the RF environment at the RRH from the received signals.

13. The system as in claim 12, wherein the signal processing section is further operable to compute a frequency response due to interfering signals based on the relationship:
$${C}_{xy} ( f ) = \frac{{\vert \overline{{S}_{xy}} ( f ) \vert}^{2}}{\overline{{S}_{xx}} ( f ) * \overline{{S}_{yy}} ( f )}$$

14. The system as in claim 1 wherein the signal processing section is further operable to detect an anomaly by estimating the spectral density of the signals in the RF environment at the RRH from the received signals.

15. The system as in claim 1 further comprising a data storage section operable to store the received signal vectors, detected anomalies and the displayed visualizations.

16. The system as in claim 1 further comprising:
an RRH, RF conversion and filter section for down converting over the air RF signals into digital signals;
an RRH signal capture section for capturing the down converted digital signals and preprocessing the signals; and
a second transceiving section at the RRH for transmitting the preprocessed signals from the RRH over the network to the first receiving section.

17. The system as in claim 16 wherein the first receiving section, signal processing section and the interface are part of a network element management system.

18. A method for analyzing the operation of a radio frequency (RF) remote radio head comprising:
receiving signals from a tower mounted, remote radio head (RRH), the signals comprising information related to signals from an RF environment at the RRH;
processing the received signals in the time and frequency domains to identify one or more anomalies due to internal or external interfering signals from the RF environment at the RRH; and
displaying a visualization of the one or more anomalies.

19. The method as in claim 18 further comprising detecting an anomaly by estimating the spectral content of the signals in the RF environment at the RRH based on the received signals.

20. The method as in claim 19 further comprising detecting an anomaly by identifying one or more acceptable or interfering RF signals in the RF environment at the RRH from the received signals based on a time and frequency analysis.
